(19) United States
(12) Patent Application Publication
(10) Pub. No.: US 2013/0258241 A1
(43) Pub. Date: Oct. 3, 2013

(54) LIQUID CRYSTAL DISPLAY APPARATUS

(71) Applicants: Emi HIGANO, Nonoichi-shi (JP); Shigesumi Araki, Hakusan-shi (JP); Kazuhiro Nishiyama, Kanazawa-shi (JP); Daiichi Suzuki, Nonoichi-shi (JP)

(72) Inventors: Emi HIGANO, Nonoichi-shi (JP); Shigesumi Araki, Hakusan-shi (JP); Kazuhiro Nishiyama, Kanazawa-shi (JP); Daiichi Suzuki, Nonoichi-shi (JP)

(21) Appl. No.: 13/827,528

(22) Filed: Mar. 14, 2013

(30) Foreign Application Priority Data
Mar. 27, 2012 (JP) 2012-071261

(51) Int. Cl. G02F 1/1335

(52) U.S. Cl. CPC G02F 1/133606
USPC 349/61

(57) ABSTRACT

According to one embodiment, a liquid crystal display apparatus includes a display panel, an illumination module which illuminates the display panel, a display controller which controls gradation display which corresponds to an image signal in a first subframe period, and non-gradation display which does not correspond to the image signal in a second subframe period, and performs control in a manner that scanning starting from an upper end and going toward center of the display panel and scanning starting from a lower end and going toward the center of the display panel are alternately performed, and an illumination controller which controls turning on/off of the illumination module.

### CROSS-REFERENCE TO RELATED APPLICATIONS

This application is based upon and claims the benefit of priority from Japanese Patent Application No. 2012-071261, filed Mar. 27, 2012, the entire contents of which are incorporated herein by reference.

### FIELD

Embodiments described herein relate generally to a liquid crystal display apparatus.

### BACKGROUND

Liquid crystal display apparatuses have been widely used as display panels which display images, in computers, car navigation systems, or televisions.

The liquid crystal display apparatuses generally display one two-dimensional information item, but are not limited to it. Liquid crystal display apparatuses which can perform three-dimensional display, or image display (multi-view display) which simultaneously provides different pictures on the same display according to the viewing direction of the viewer. For example, proposed are two-picture display apparatuses which are mounted onto vehicles and enables the users to view different images from the driver's seat and the front seat next to the driver, and three-dimensional display apparatuses which display a right-eye image and a left-eye image and thereby perform three-dimensional display.

In addition, it has been proposed to switch the light directivity by distributing light in the right and left directions by multiplexing driving. According to this method, it is possible to display a plurality of pictures or display a three-dimensional image, without reducing the spatial resolution or aperture ratio.

In the meantime, when color images are displayed in a field-sequential method, a frame is divided into three subframes for displaying RGB images, and driving of turning on backlight for each sub-frame is adopted.

Also in three-dimensional display and multi-view display, adopted is driving of dividing one frame into two subframes for displaying right and left images, and turning on backlight for each subframe.

As described above, the method of switching and displaying a plurality of images for each sub-frame, and turning on the backlight for each sub-frame requires performing scanning a plurality of times in a period of a frame. Therefore, there are cases where unevenness in in-plane brightness and color irregularity become obvious, due to reduction in the display period.

### BRIEF DESCRIPTION OF THE DRAWINGS

FIG. 1 is an exemplary diagram for explaining an outline of a liquid crystal display apparatus according to a first embodiment.

FIG. 2 is an exemplary block diagram illustrating configuration of the liquid crystal display apparatus according to the first embodiment.

FIG. 3 is an exemplary diagram illustrating a conventional method of scanning a liquid crystal display panel.

FIG. 4 is an exemplary diagram for explaining the cause of occurrence of uneven brightness and color irregularity.

FIG. 5 is an exemplary diagram illustrating a method of scanning a liquid crystal display panel of the liquid crystal display apparatus according to the first embodiment.

FIG. 6 is an exemplary timing chart illustrating a method of driving the liquid crystal display apparatus according to the first embodiment.

FIG. 7 is an exemplary diagram illustrating a method of scanning a liquid crystal display panel of a liquid crystal display apparatus according to a second embodiment.

FIG. 8 is an exemplary timing chart illustrating a method of driving the liquid crystal display apparatus according to the second embodiment.

### DETAILED DESCRIPTION

In general, according to one embodiment, a liquid crystal display apparatus includes a display panel in which a plurality of liquid crystal pixels are arranged in rows and columns; an illumination module which illuminates the display panel; a display controller which controls gradation display which corresponds to an image signal in a first subframe period that is shorter than a frame period, and non-gradation display which does not correspond to the image signal in a second subframe period that is different from the first subframe period, and performs control in a manner that scanning going from an upper end to center of the display panel and scanning going from a lower end to the center of the display panel are alternately performed in scanning operation for the gradation display and the non-gradation display; and an illumination controller which controls turning on/off of the illumination module, in correspondence with periods of the gradation display and the non-gradation display.

### First Embodiment

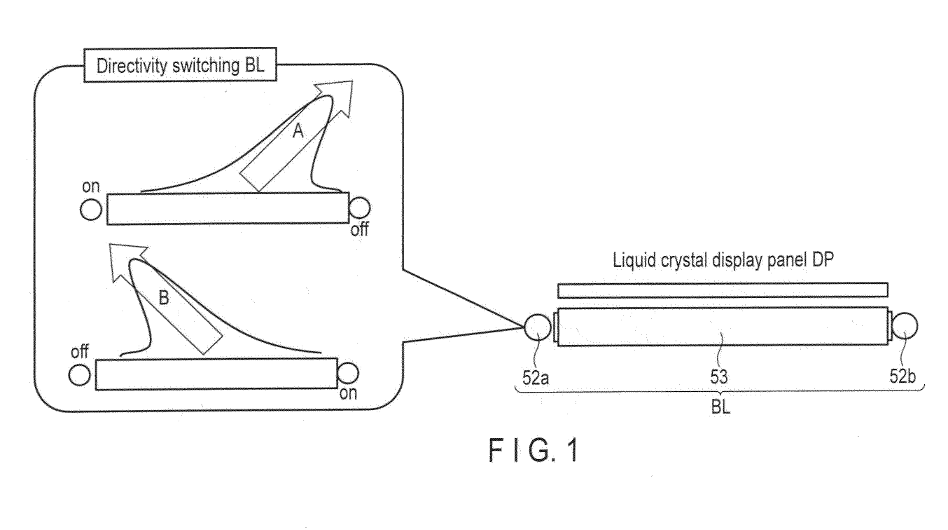

FIG. 1 is an exemplary diagram for explaining an outline of a liquid crystal display apparatus according to a first embodiment.

In the liquid crystal display apparatus according to the present invention, a backlight BL is provided under a transmissive liquid crystal display panel DP. The backlight BL is formed of a light source 52a, a light source 52b, and a backlight light-guiding panel 53. When the light source 52a is turned on, the light is caused to exit in a right direction in the drawing by the backlight light-guiding panel 53. When the light source 52b is turned on, the light is caused to exit in a left direction in the drawing by the backlight light-guiding panel 53.

When multi-view display is performed, the light source 52a is turned on for a period for which a right image is displayed on the liquid crystal display panel DP, and the light sources are switched and the light source 52b is turned on for a period for which a left image is displayed on the liquid crystal display panel DP. As described above, right and left images are successively displayed on the liquid crystal display panel DP in a time-division manner, and the directivities of the light sources which illuminate the display panel are switched in synchronization with display of the images. Thereby, the right and left images can be guided to respective desired directions.

FIG. 1 illustrates a schematic structure of the liquid crystal display apparatus. In the actual display apparatus, it is possible to further provide an optical element, such as a collimator lens and a prism film, which controls light directivity, between the liquid crystal display panel DP and the backlight BL.

To divide a period for a frame in a time-division manner and display different images, it is indispensable to use liquid crystal which requires a short response time. Therefore, the present embodiment adopts liquid crystal exhibiting optically compensated bend (OCB) mode, which has the high-speed liquid crystal responsiveness required for displaying moving pictures and can achieve a wide viewing angle.

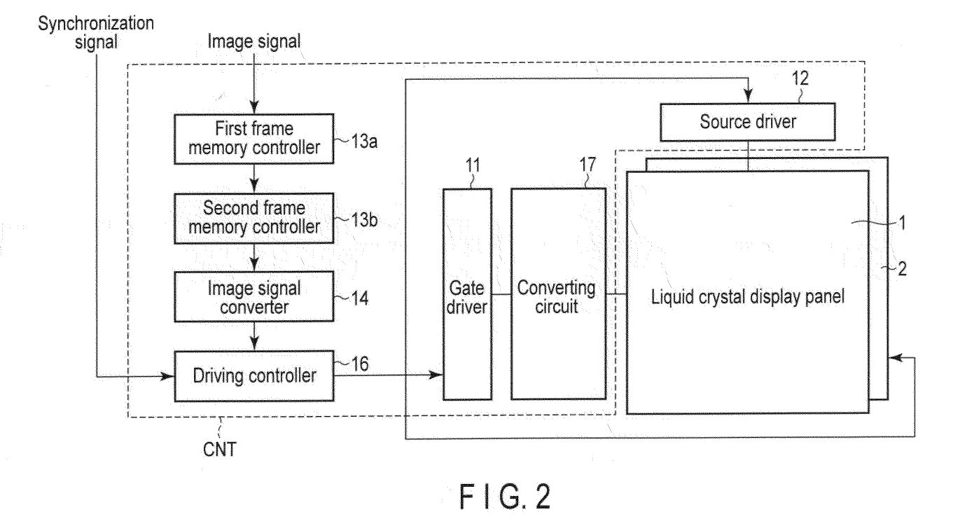

FIG. 2 is an exemplary block diagram illustrating configuration of the liquid crystal display apparatus according to the first embodiment.

The liquid crystal display apparatus comprises a liquid crystal display panel 1, a backlight 2 which illuminates the liquid crystal display panel 1, and a controller CNT which controls display operation.

The liquid crystal display panel 1 has a structure in which a liquid crystal layer is held between an array substrate (not shown) and an opposite substrate (not shown), which are a pair of electrode substrates.

In the OCB-mode liquid crystal display panel 1, liquid crystal molecules have splay alignment, in which the liquid crystal molecules are almost laid down, before the power is turned on, by alignment films which are rubbed in almost parallel with each other on pixel electrodes and a common electrode. The liquid crystal display panel 1 performs display operation, after the liquid crystal molecules transition from splay alignment to bend alignment by a comparatively strong electric field which is applied in initialization that is performed when the power is turned on.

The OCB-mode liquid crystal having the above structure has a characteristic that the liquid crystal which has once transitioned to bend alignment reversely transitions to splay alignment again, when a state of applying a voltage of a level, which is equal to or less than a level at which the energy of splay alignment competes with the energy of bend alignment, or a state in which no voltage is applied continues for an extended time. The viewing angle characteristic of splay alignment is greatly different from that of bend alignment, and thus display malfunction occurs.

To prevent reverse transition from bend alignment to splay alignment, known are a driving method of applying a large voltage enough to prevent reverse transition to the OCB liquid crystal in part of a frame period for which an image of a frame is displayed, and a driving method of not using a voltage of a level which is equal to or less than a level at which the energy of splay alignment competes with the energy of bend alignment. In a normally white liquid crystal display panel, by using a black display voltage as a reverse-transition-preventing voltage in the former driving method, it is possible to effectively prevent reverse transition and improve the display performance for moving pictures, which is called “black insertion driving”.

The liquid crystal layer which is used in the present embodiment is OCB-mode liquid crystal, which transitions from splay alignment to bend alignment in advance to perform normally white display operation, and is prevented from reversely transitioning from bend alignment to splay alignment by adopting black insertion driving of periodically applying voltage which generates black display.

The array substrate is provided with a plurality of pixel electrodes which are arranged in rows and columns, and the opposite substrate is provided with a black matrix, which prevents light leakage, and an opposite electrode. Each pixel is formed of each pixel electrode, the opposite electrode, and the liquid crystal layer.

The controller CNT applies a liquid crystal driving voltage to the liquid crystal layer between the pixel electrodes and the opposite electrode through the array substrate and the opposite substrate, and controls transmittance of each pixel by the generated electric field.

The controller CNT includes a gate driver 11, a source driver 12, a first frame memory controller 13a, a second frame memory controller 13b, an image signal converter 14, a driving controller 16, and a converting circuit 17.

The gate driver 11 successively drives gate lines (not shown), each of which selects a plurality of pixels of the corresponding row, through the converting circuit 17. The selected pixels of the row are changed to a state in which a pixel voltage that corresponds to a display signal can be written in the pixel. The converting circuit 17 selects the gate lines in a predetermined order, in response to a signal from the gate driver 11. The source driver 12 outputs pixel voltages to be written in selected pixels of the respective lines to a plurality of source lines (not shown).

The first frame memory controller 13a is a buffer memory which temporarily stores a digital image signal. The second frame memory controller 13b changes the order of data items of the digital image signal taken out of the first frame memory controller 13a, and stores the digital image signal with the changed order.

The image signal converter 14 generates a signal to be displayed on the liquid crystal display panel 1 from the digital image signal stored in the second frame memory 13b.

The driving controller 16 generates pixel voltages from the digital signals obtained by the image signal converter 14 as a conversion result, based on synchronization signals input from an external signal source (not shown), and successively outputs the pixel voltages as source signals. The driving controller 16 also generates gate signals which are control signals for the gate driver 11, based on the synchronization signals input from the external signal source. In addition, the driving controller 16 outputs signals for controlling turning on/off of the backlight 2, based on the synchronization signals input from the external signal source.

The following is explanation of deterioration in display quality, which occurs when the liquid crystal display apparatus is operated by a conventional driving method.

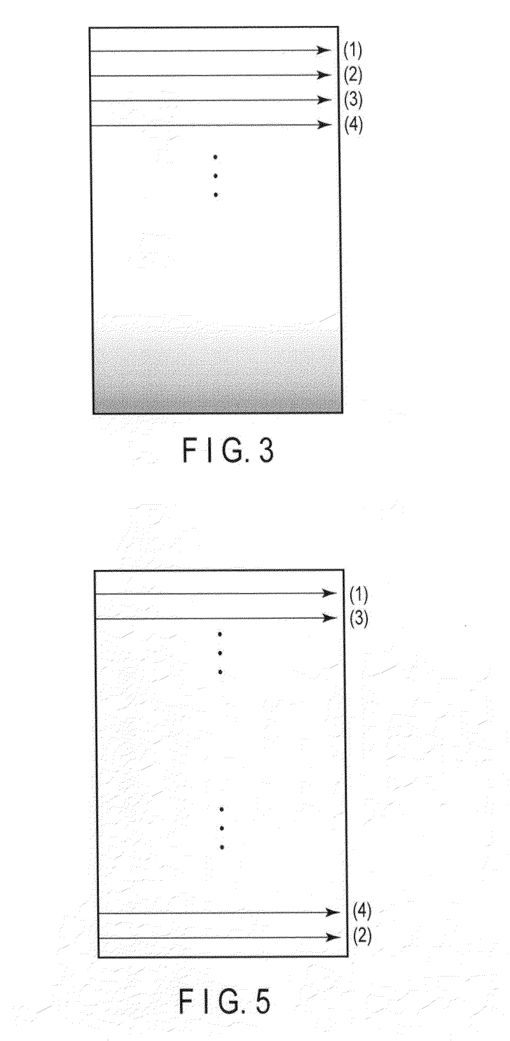

FIG. 3 is an exemplary diagram illustrating a conventional method of scanning a liquid crystal display panel. In prior art, the lines of the liquid crystal display panel 1 are successively selected from the head line to the last line, to successively write an image signal in the lines in the selected order. When the scanning method is applied to a liquid crystal display apparatus which performs drive scanning a plurality of times in a time period of a frame, however, deterioration in display quality, such as unevenness in brightness and color irregularity, is recognized by sight.

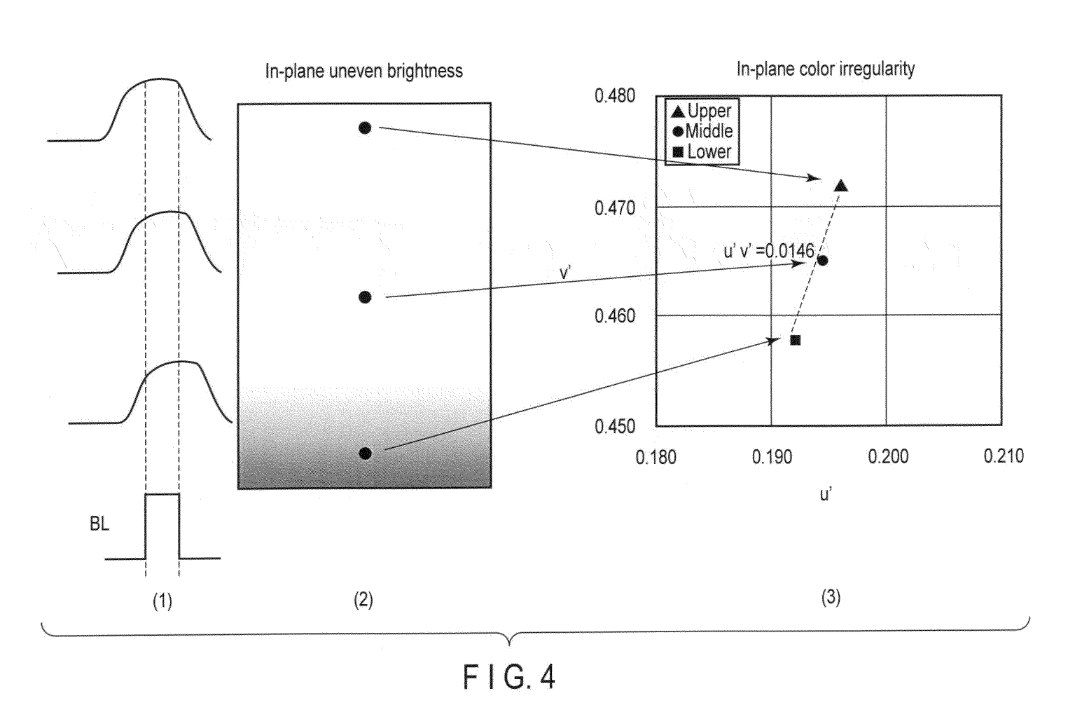

FIG. 4 is an exemplary diagram for explaining the cause of occurrence of unevenness in brightness and color irregularity.

FIG. 4 (1) illustrates transitions, with the passage of time, of transmittance of liquid crystals in the upper part, middle part, and lower part of the liquid crystal display panel 1. The transmittance during a period for which the backlight BL is turned on is observed as gradient. The time required from application of voltages to liquid crystals until turning on the backlight BL differs between the upper part, the middle part, and the lower part. When the backlight is turned on, the transmittance of the liquid crystal of the upper part reaches a predetermined value, while the transmittance of the liquid crystal of the lower part has not reached the predetermined value yet. Therefore, as illustrated in FIG. 4 (2), the upper part, the middle part, and the lower part have different transmittances, and unevenness in brightness occurs.

FIG. 4 (3) illustrates colors of pixels in the upper part, the middle part, and the lower part of the liquid crystal display panel 1 by a CIELUV chromaticity diagram. According to the chromaticity diagram, although the same color is to be displayed on the display panel 1, different colors are recognized by sight. Specifically, occurrence of color irregularity is observed. This is because R, G, and B pixels do not have the same transmittance characteristic, and thus color balance is lost between the upper part, the middle part, and the lower part.

The invention of the present application is aimed at reducing unevenness in brightness and color irregularity. The technical idea thereof is reducing them by dispersing unevenness in brightness and color irregularity.

FIG. 5 is an exemplary diagram illustrating a method of scanning the liquid crystal display panel of the liquid crystal display apparatus according to the first embodiment. In the first embodiment, scanning starting from the upper end and going toward the center of the liquid crystal display panel 1 and scanning starting from the lower end and going toward the center of the liquid crystal display panel 1 are alternately performed.

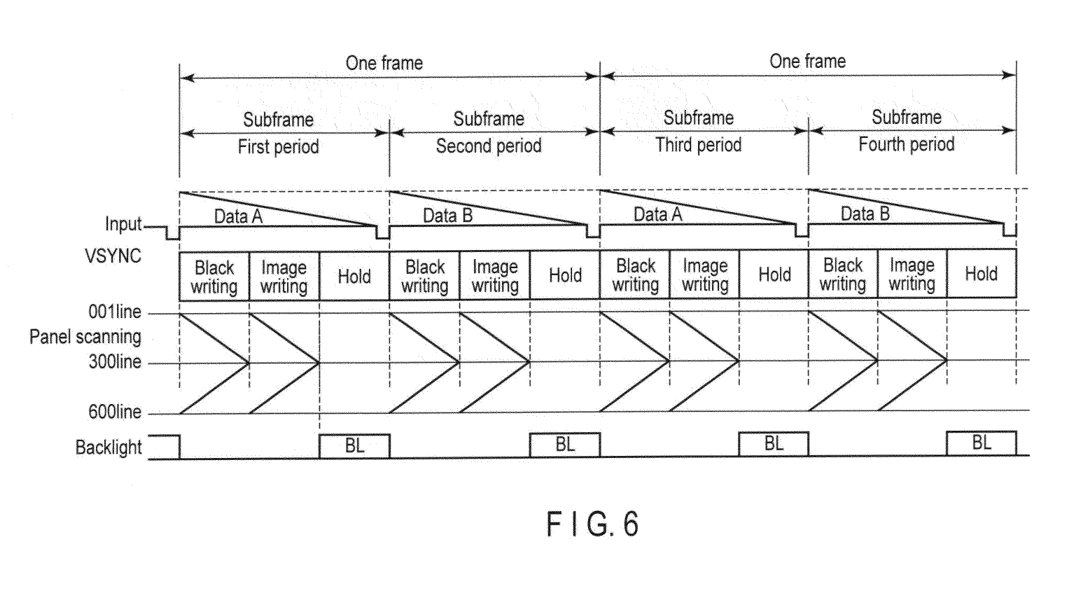

FIG. 6 is an exemplary timing chart illustrating a method of driving the liquid crystal display apparatus according to the first embodiment. The operation thereof will be explained with reference to FIG. 2 to FIG. 6. In FIG. 6, suppose that the number of lines in the row direction of the liquid crystal display panel 1 is 600.

In FIG. 6, a frame is formed of two subframes. The periods of the respective subframes are referred to as a first period, a second period, . . . , in sequential order.

In the first period, data A is input as an image signal to the controller CNT. Data A is temporarily stored in the first frame memory controller 13a, and thereafter written in the second frame memory controller 13b at a predetermined timing. Thereafter, the first frame memory controller 13a can receive next data.

The second frame memory controller 13b changes the data order of data A. Specifically, the second frame memory controller 13b sets a data item for the upper end (001 line) of the liquid crystal display panel 1 first, and then sets a data item for the lower end (600 line) of the liquid crystal display panel 1 next.

Thereafter, the second frame memory controller 13b recomposes data A in accordance with the order illustrated in FIG. 5, that is, the second data item (002 line) from the upper end, the second data item (599 line) from the lower end, . . . , and thereby generates new data A′. The image signal converter 14 converts data A′ into a signal which is to be displayed on the liquid crystal display panel 1.

In the second period, the driving controller 16 executes black writing (black insertion driving) operation. Specifically, the driving controller 16 controls the gate driver 11 to output a signal for successively selecting the gate lines from the upper end to the lower end to the converting circuit 17. The driving controller 16 also outputs a black signal to the source driver 12.

The converting circuit 17 converts the selection signal from the gate driver 11, and changes the selection order of the gate lines. Specifically, the converting circuit 17 outputs a signal for selecting the gate lines in the order illustrated in FIG. 5.

A black oblique line which is shown in each of the periods “Black writing” in FIG. 6 indicates scanning for the above black writing.

After black writing operation is finished, the driving controller 16 executes image writing operation. Specifically, the driving controller 16 controls the gate driver 11, to output a signal for successively selecting the gate lines from the upper end to the lower end to the converting circuit 17. The driving controller 16 also outputs the image signal which has been converted by the image signal converter 14 to the source driver 12.

The converting circuit 17 converts the selection signal from the gate driver 11, and changes the selection order of the gate lines. Specifically, the converting circuit 17 outputs a signal for selecting the gate lines in the order illustrated in FIG. 5.

A black oblique line which is shown in each of the periods “Image writing” in FIG. 6 indicates scanning for the above image writing.

After image writing operation is finished, the driving controller 16 executes backlight turning-on (HOLD) operation. A rising part of the “backlight” signal in FIG. 6 indicates a state where the backlight is kept turned on. The backlight is changed to the turned-on state for a desired period, after scanning for the gradation display in the first subframe period is finished, and before scanning for the non-gradation display is started in a next subframe period.

On the other hand, in the second period, data B is input as an image signal to the controller CNT. Data B is temporarily stored in the first frame memory controller 13a, and thereafter written in the second frame memory controller 13b at a predetermined timing.

The second frame memory controller 13b changes the data order of data B in accordance with the order illustrated in FIG. 5, and generates new data B′. The image signal converter 14 converts data B′ into a signal to be displayed on the liquid crystal display panel 1.

The image signal of data B′ is used in the next third period. Operation performed in the third period is the same as the operation in the second period, and detailed explanation thereof is omitted.

### Second Embodiment

The second embodiment is different from the first embodiment in the method of scanning the liquid crystal display panel 1. Therefore, constituent elements which are the same as those in the first embodiment are denoted by the same respective reference numerals, and detailed explanation thereof is omitted.

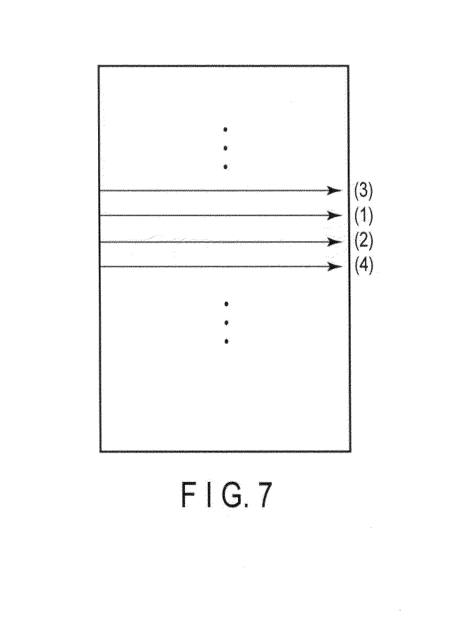

FIG. 7 is an exemplary diagram illustrating a method of scanning a liquid crystal display panel of a liquid crystal display apparatus according to the second embodiment. In the second embodiment, scanning starting from the center and going toward the upper end of a liquid crystal display panel 1 and scanning starting from the center and going toward the lower end of the liquid crystal display panel 1 are alternately performed.

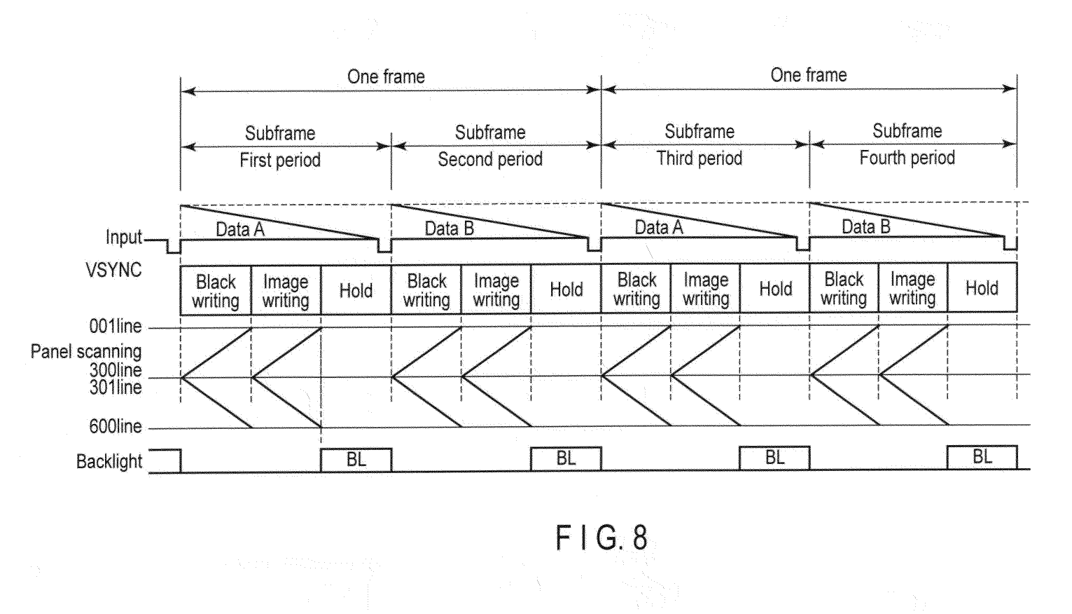

FIG. 8 is an exemplary timing chart illustrating a method of driving the liquid crystal display apparatus according to the second embodiment.

In FIG. 8, a frame is formed of two subframes. Periods of the respective subframes are referred to as first period, second period, . . . , in sequential order.

In the first period, data A is input as an image signal to a controller CNT. Data A is temporarily stored in a first frame memory controller 13a, and thereafter written in a second frame memory controller 13b at a predetermined timing. Thereafter, the first frame memory controller 13a can receive next data.

The second frame memory controller 13b changes the data order of data A. Specifically, the second frame memory controller 13b sets a data item for the center (300 line) of the liquid crystal display panel 1 first, and then sets a data item for the center (301 line) of the liquid crystal display panel 1 next. Thereafter, the second frame memory controller 13b recomposes data A in accordance with the order illustrated in FIG. 7, that is, a second data item (299 line) from the center toward the upper end, a second data item (302 line) from the center toward the lower end, . . . , and thereby generates new data A′. An image signal converter 14 converts data A′ into a signal to be displayed on the liquid crystal display panel 1.

In the second period, a driving controller 16 performs black writing (black insertion driving) operation. Specifically, the driving controller 16 controls a gate driver 11 to output a signal for successively selecting gate lines from the upper end to the lower end to a converting circuit 17. The driving controller 16 also outputs a black signal to a source driver 12.

The converting circuit 17 converts the selection signal from the gate driver 11, and changes the selection order of the gate lines. Specifically, the converting circuit 17 outputs a signal for selecting the gate lines in the order illustrated in FIG. 7.

A black oblique line shown in each of the periods “black writing” in FIG. 8 indicates scanning for the above black writing.

After the black writing operation is finished, the driving controller 16 performs image writing operation. Specifically, the driving controller 16 controls the gate driver 11 to output a signal for successively selecting the gate lines from the upper end to the lower end. The driving controller 16 also outputs the image signal converted by the image signal converter 14 to the source driver 12.

The converting circuit 17 converts the selection signal from the gate driver 11, and changes the selection order of the gate lines. Specifically, the converting circuit 17 outputs a signal for selecting the gate lines in the order illustrated in FIG. 7.

A black oblique line shown in each of the periods “image writing” in FIG. 8 indicates scanning for the above image writing.

After image writing operation is finished, the driving controller 16 executes backlight turning-on (HOLD) operation. A rising part of the “backlight” signal in FIG. 8 indicates a state where the backlight is kept turned on. The backlight is changed to the turned-on state for a desired period, after scanning for the gradation display in the first subframe period is finished, and before scanning for the non-gradation display is started in a next subframe period.

On the other hand, in the second period, data B is input as an image signal to the controller CNT. Data B is temporarily stored in the first frame memory controller 13a, and thereafter written in the second frame memory controller 13b at a predetermined timing.

The second frame memory controller 13b changes the data order of data B in accordance with the order illustrated in FIG. 7, and generates new data B′. The image signal converter 14 converts data B′ into a signal to be displayed on the liquid crystal display panel 1.

The image signal of data B′ is used in the next third period. Operation performed in the third period is the same as the operation in the second period, and detailed explanation thereof is omitted.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display apparatus comprising:
a display panel in which a plurality of liquid crystal pixels are arranged in rows and columns;
an illumination module which illuminates the display panel;
a display controller which controls gradation display which corresponds to an image signal in a first subframe period that is shorter than a frame period, and non-gradation display which does not correspond to the image signal in a second subframe period that is different from the first subframe period, and performs control in a manner that scanning starting from an upper end and going toward center of the display panel and scanning starting from a lower end and going toward the center of the display panel are alternately performed in scanning operation for the gradation display and the non-gradation display; and
an illumination controller which controls turning on/off of the illumination module, in correspondence with periods of the gradation display and the non-gradation display.

2. The liquid crystal display apparatus of claim 1, wherein
the subframe periods are successive periods in a frame period.

3. The liquid crystal display apparatus of claim 2, wherein
the liquid crystal pixels are formed of OCB-mode liquid crystal.

4. The liquid crystal display apparatus of claim 3, wherein
the illumination controller controls the illumination module to a turned-on state for a desired period, after scanning for the gradation display in the first subframe period is finished, and before scanning for the non-gradation display is started in a next subframe period.

5. A liquid crystal display apparatus comprising:
a display panel in which a plurality of liquid crystal pixels are arranged in rows and columns;
an illumination module which illuminates the display panel;
a display controller which controls gradation display which corresponds to an image signal in a first subframe period that is shorter than a frame period, and non-gradation display which does not correspond to the image signal in a second subframe period that is different from the first subframe period, and performs control in a manner that scanning starting from center and going toward an upper end of the display panel and scanning starting from the center and going toward a lower end of the display panel are alternately performed in scanning operation for the gradation display and the non-gradation display; and
an illumination controller which controls turning on/off of the illumination module, in correspondence with periods of the gradation display and the non-gradation display.

6. The liquid crystal display apparatus of claim 5, wherein
the subframe periods are successive periods in a frame period.

7. The liquid crystal display apparatus of claim 6, wherein
the liquid crystal pixels are formed of OCB-mode liquid crystal.

8. The liquid crystal display apparatus of claim 7, wherein
the illumination controller controls the illumination module to a turned-on state for a desired period, after scanning for the gradation display in the first subframe period is finished, and before scanning for the non-gradation display is started in a next subframe period.
